(19) United States
(12) Patent Application Publication
(10) Pub. No.: US 2012/0037446 A1
(43) Pub. Date: Feb. 16, 2012

(54) UNIFORM DISPLACEMENT SWEEP

(75) Inventors: Peter M. Eick, Houston, TX (US); Joel D. Brewer, Houston, TX (US); Shan Shan, Houston, TX (US); Frank D. Janiszewski, Richmond, TX (US)

(73) Assignee: ConocoPhillips Company, Houston, TX (US)

(21) Appl. No.: 13/192,250

(22) Filed: Jul. 27, 2011

Related U.S. Application Data
(60) Provisional application No. 61/372,318, filed on Aug. 10, 2010.

(51) Int. Cl. G01V 1/04

(52) U.S. Cl. 181/121

(57) ABSTRACT

This invention relates to operating a seismic vibrator to produce a uniform displacement sweep wherein the baseplate drive is connected to the baseplate and the baseplate is moved in an up and down or reciprocating pattern creating displacement of the earth. The reciprocating pattern and physical displacement of the baseplate and the ground in contact with the baseplate is maintained at a relatively constant distance over at least most of the frequencies that are delivered into the earth although a constant displacement of the baseplate at higher frequencies will require greater power. The high frequency energy is more significantly present in the data traces of the recorded return wavefield and shows that Q attenuation is not fully to blame for the relative absence of high frequency data but rather in failing to effectively deliver high frequency energy into the earth in the first place.

### CROSS-REFERENCE TO RELATED APPLICATIONS

This application is a non-provisional application which claims benefit under 35 USC §119(e) to U.S. Provisional Application Ser. No. 61/372,318 filed Aug. 10, 2010, “Uniform Displacement Sweep,” which is incorporated herein in its entirety.

### STATEMENT REGARDING FEDERALLY SPONSORED RESEARCH OR DEVELOPMENT

None.

### FIELD OF THE INVENTION

This invention relates to the acquisition of seismic data and especially to sweep-type vibratory sources that provide seismic energy into the ground and create reflections from subsurface geology that is received and recorded in the form of seismic data.

### BACKGROUND OF THE INVENTION

Historically, the acquisition of seismic data was accomplished by creating an explosion that propagated a broad frequency spectrum of seismic energy into the ground. The energy carried down into the ground reflecting and refracting off and through the various strata below the surface and the returning wavefield was recorded. This type of seismic acquisition was slow and dangerous.

In the 1950's, Conoco developed sweep-type vibrators that reduced the energy intensity of the explosion by spreading the smaller energy over a longer period of time as shown in U.S. Pat. Nos. 2,688,124, 3,024,861, 3,073,659, 3,159,233, 3,209,322, and 3,293,598, etc., for example. This certainly improved safety while still providing a frequency spectrum of energy into the ground. Sweep-type vibrators have now been in common use for over 50 years. The seismic surveys accomplished with sweep-type seismic sources are reliable and consistent and, most importantly, are safer than taking explosives into the field. However, it has long been recognized that high frequency energy provides a level of detail in the seismic record that is highly desirable, but the intensity or amplitude of the high frequency energy in the data record has been less than desirable.

Conventional efforts to increase the recordable high frequency energy have been primarily focused on providing longer sweeps or to lengthen the proportion of the sweep time for which the higher frequency energy is delivered into the ground, ie manipulating the dwell or gain of the sweep. As a sweep-type vibrator delivers the seismic energy into the ground, it records each sweep and computes an approximate ground force delivered into the ground for use by a feedback circuit to control the vibe. This ground force approximation is used in subsequent analysis in seismic data processing. Conventional vibrator technology uses a weighted-sum method to approximate the “ground force” during a sweep. In 1984, Sallas derived the weighted-sum method to approximate the true ground force. See J. J. Sallas, Seismic Vibrator Control and the Downgoing P-Wave, GEOPHYSICS 49(6) (1984) 732-40. The weighted-sum method assumes that a baseplate acts as a rigid body, and that a full coupling between the baseplate and the ground is achieved. Under these assumptions, the weighted-sum ground force is obtained by summing the weighted baseplate and reaction mass accelerations. The Sallas approximation or equation may be written as:

−F_{g}=MᵣAᵣ+M_{b}A_{b},

where Mᵣ=Mass of the reaction mass (kg); M_{b}=Mass of the baseplate (kg); Aᵣ=Reaction mass acceleration (m/s²); A_{b}=Baseplate acceleration (m/s²); and F_{g}=Compressive force exerted on the earth by the baseplate (N). This is normally reported as the ground force of the vibrator.

The dynamics of vibrator systems seems to inherently limit the power that is deliverable into the ground at high frequency. A low frequency is delivered by a longer, slower stroke of the reaction mass while a higher frequency stroke is fast and typically shorter in length. The Sallas approximation indicates that a fast stroke of shorter length provides equal force to the ground, the absence of the higher frequency data in the data traces or records from the field could mean that either the true force is not what is approximated by the Sallas equation or that consistent force across a broad frequency spectrum does not deliver consistent energy delivery across a broad frequency spectrum.

### BRIEF SUMMARY OF THE DISCLOSURE

The invention more particularly relates to a method of operating a seismic vibrator having a baseplate, a baseplate drive connected to the baseplate and arranged for causing up and down motion of the baseplate so as to produce a uniform displacement sweep. The method includes putting the baseplate to the ground to be coupled to the earth and operating the baseplate drive over the desired frequency sweep such that the baseplate moves in an up and down motion and displaces the ground underneath it by a substantially consistent displacement distance over the frequency sweep up to at least 40 Hz.

In another aspect of the present invention, the invention relates to a method of operating a seismic vibrator having a baseplate, a baseplate drive connected to the baseplate and arranged for causing up and down motion of the baseplate on the ground so as to deliver pulses into the ground where the pulses are delivered across a range of frequencies during a sweep. This includes putting the baseplate to the ground to be coupled to the earth and operating the baseplate drive at a frequency above 40 Hz. The displacement of the baseplate is measured as the pulses are delivered into the ground so as to obtain a measured displacement. The displacement of the baseplate is then set for most frequencies in the sweeps using in the survey to be approximately the measured displacement.

In another aspect of the present invention, the invention relates to a method of operating a seismic vibrator having a baseplate, a baseplate drive system including a reaction mass associated with the baseplate where the baseplate drive system causes movement of the reaction mass in a vertical up and down motion so as to produce impulses through the baseplate into the ground. The method includes putting the baseplate to the ground to be coupled to the earth and operating the baseplate drive system through a sweep where a sweep comprises moving the reaction mass up and down through a physical displacement distance while changing the frequency at which the reaction mass moves at a start frequency and progresses to an end frequency and through the frequencies between the start frequency and end frequency wherein the physical displacement distance of the reaction mass is maintained to be substantially consistent through the sweep up to at least 40 Hz.

### BRIEF DESCRIPTION OF THE DRAWINGS

A more complete understanding of the present invention and benefits thereof may be acquired by referring to the follow description taken in conjunction with the accompanying drawings in which:

FIG. 1 is a cross-sectional view of a conventional seismic vibrator on an array of load sensors.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

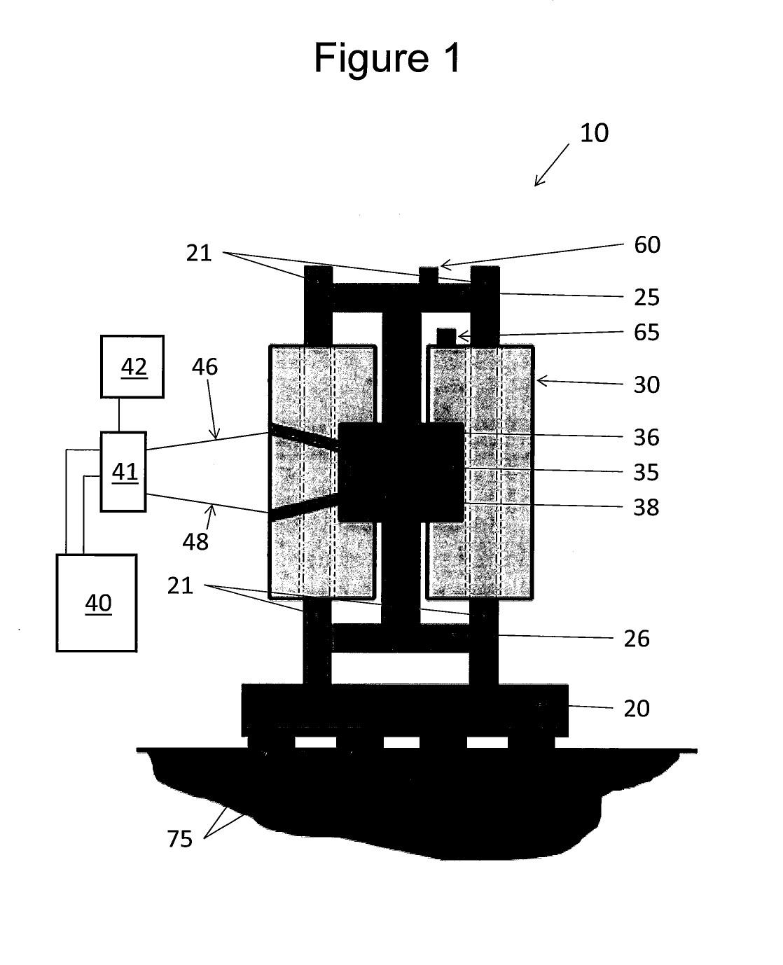

As noted above, it has been difficult to acquire suitable high frequency data when using sweep-type vibratory seismic sources and investigations pursuant to the present invention have turned toward an analysis of the energy that sweep-type vibratory seismic sources are actually putting into the ground in hopes of increasing the presence of high frequency data in the returning wavefield. For explaining the invention, a conventional sweep-type vibratory seismic source is illustrated in FIG. 1.

A simplified version of the operable portion of a conventional seismic vibrator is generally indicated by the arrow 10. The primary operative element is baseplate 20 that is lowered to the ground 55 and held down typically using the weight of the vehicle that carries vibrator 10. Typically, vibrator 10 is carried along under the belly of the vehicle and lowered to the ground once located at a shot point or source point. While the weight of the vehicle is used to hold the baseplate to the ground, it is typically isolated from the intense vibration by pneumatic dampeners that are not shown. The second operative element of the vibrator is reaction mass 30 that is positioned to slide up and down along guide rods 21. The reaction mass 30 is a heavy and substantial sized block of metal and is intended to be forcefully moved up and down to create impulses that are passed into the ground 55 through baseplate 20.

The reaction mass 30 is driven up and down along guide rods 21 by a hydraulic system, schematically indicated by box 40, where hydraulic fluid is delivered through a valving system 41 and into and through channels 46 and 48. Upper and lower cylinders 36 and 38 are rapidly filled and drained of hydraulic fluid to drive the reaction mass 30 relative to piston 35. Vibe controller 42 controls the valving system 41 thereby controlling the speed and direction of the reaction mass and ultimately the frequency and force at which the reaction mass moves. The hydraulic system 40 typically includes a diesel powered hydraulic pump. As noted above, this is the basic arrangement of a conventional sweep-type vibrator. A baseplate accelerometer 60 measures the acceleration of the baseplate 20 while a reaction mass accelerometer 65 is mounted on the reaction mass 30 to record the acceleration of the reaction mass 30.

Continuing with the discussion of the analysis of the seismic source, the vibrator 10 is operated to generate seismic energy, but using one or more load sensors between the baseplate 20 and the ground. As shown in FIG. 1, an array of load sensors 75 are placed under the baseplate 20 to more accurately measure the true ground force produced at each frequency to determine the actual ground force (F_{g}) applied to the earth over a range of frequencies. Load sensors are described in the publication “Load Cell System Test Experience: Measuring the Vibrator Ground Force on Land Seismic Acquisition”, Shan, S., et al. SEG Expanded Abstracts, 0016-0020 (October 2009) Although it is known that vibes provide a ground source estimate that is used for inversion and subsequent data processing, it turns out that current vibrators do not provide accurate information about the ground force actually delivered to the ground. The load sensors provide more accurate data and this has been confirmed by experiments using seismic receivers installed in boreholes deep in the ground. It should be emphasized that these experiments confirmed two important observations. First, the vibrators do not actually impart the ground force to the earth they report based on the ground force data computed by the vibrator controller based on the Sallas estimation, especially at higher frequencies. And secondly, the load sensors provide a relatively accurate ground force measurements across the frequency spectrum.

The information provided by the vibrator controller is sufficiently accurate at lower frequencies, but inaccuracy begins at about 35 Hz and continues to deviate as the frequency being delivered gets higher. The actually becomes unacceptable under most conventional ground conditions at frequencies of about 40 to 50 Hz in the sweep for most terrains using industry standard 60,000+ lbs vibrators. Specifically, most large industry standard seismic vibrators begin to reduce the actual ground force at about 35 Hz (as compared to what the vibrator actually reports via the vibe controller and the Sallas Approximation), and the ground force is quite variable above about 40 to 50 Hz. Much above 60 Hz and the forces in the sweeps are highly unstable and do not reflect the signal that is desired to be imparted to the ground and as reported by either the load cell data nor the data from the receivers in the well bore. In more simple and brutal terms, the vibe reports it is doing the sweep nearly perfectly and it is actually doing a terrible job putting the sweep into the ground. Essentially, the vibrators “lie” about how good of a job they are doing.

In a preferred embodiment, the true ground force imparted to the earth from a seismic vibrator is recorded using a load sensor device or an array of load sensor devices. The seismic vibrator controller electronics 42 is supplied a pilot sweep that represents the desired source signature. The pilot sweep is a sinusoidal function that varies in frequency with time. It is used by the vibrator control electronic system 41 as a representation for the desired motion of the baseplate 20 and reaction mass 30. The motion of the baseplate 20 is then translated into ground force through impulses with the earth. Ground force is actually weight that varies in time in a similar manner to the way the pilot sweep's sinusoidal shape varies in time. The ground force measured by the array of load sensors and the pilot sweep are then directly related and are also directly related to the desired true ground force.

In the analysis of the present invention, it was observed that the Sallas equation shows that, at low frequencies, a vibrator's baseplate 20 has a large displacement, or movement up and down, that generates a large force on the captured mass of the ground 55. This can be readily observed during the sweep as large ground displacements in the baseplate that can be physically seen.

At higher frequencies, the conventional vibrator 10 is operated so that baseplate 20 has increasingly smaller displacements at higher velocities or accelerations. However, at high frequencies, this force is created via quick acceleration of the reaction mass pushing and therefore, the baseplate assembly 20 (and captured earth mass 55) is moved through smaller displacements at higher velocities that can no longer be observed with the human eye. Thus, the Sallas equation or approximation assumes that the force should be maintained constant. The premise of the present invention is that the displacement of the earth should be held constant regardless of the force that may actually be applied to the earth.

So, for the present invention, the vibrator should maintain a uniform stroke length (i.e., consistent amplitude) of the baseplate during the entire sweep. A uniform stroke length provides consistent amplitudes regardless of the frequency, and increases the vibrator's signal output at higher frequencies that would reduce the effects of Q attenuation.

However, traditional vibrator designs impose physical limits on the vibrator's signal output. A seismic vibrator 10 has a limited potential energy output. The engines that drive the hydraulics of seismic vibrators 10 have a maximum horsepower rating and thus, there is a limit on the power output. Since the present invention would intend to use the most energy at the higher frequencies, the power output is most limited at the higher frequencies.

It should also be recognized that current operation procedures for conventional vibes include reduced stroke length for the reaction mass as the frequency increases. While the preferred invention is to impose a consistent stroke length of the reaction mass across the sweep of a frequency spectrum, typically from about 4 or 5 Hz up to at least about 60 to maybe 90 Hz, maintaining at least a consistent stroke length of the reaction mass across most of the sweep would be an improvement over current technology.

In another aspect of the present invention, the measurement of the stroke length of either or both of the reaction mass and the baseplate and the ground that is under the baseplate and coupled therewith during a sweep would occur through suitable loop feedback systems.

Accordingly, in an alternative embodiment of the present invention the seismic vibrator 10 may be operated to reduce the piston stroke (i.e., amplitude) and the displacement distance of the baseplate 20 at lower frequencies so that energy within the capabilities of the vibrator 10 may be imparted into the earth at higher frequencies using the same, but smaller, displacement that is used for the lower frequencies.

The present invention is method of operating a seismic vibrator to produce a uniform displacement sweep. In an embodiment, the seismic vibrator 10 is set up so that, regardless of the operational frequency, the seismic vibrator 10 maintains a uniform piston stroke (i.e., consistent amplitude), and displaces the baseplate 20 a consistent linear distance during at least a portion of the uniform displacement sweep. In particular, the seismic vibrator's Sallas-type controller will have to be disabled to implement the present invention, and the vibrator is controlled manually or, alternatively, with a non-Sallas type controller. In an embodiment, the displacement distance of the baseplate 20 or stroke length of the reaction mass is between about one inch and about five inches. In another embodiment, the displacement distance is between about one and about two inches. In a preferred embodiment, the displacement distance is as large as can be consistently maintained over a broad portion of the sweep within the horsepower and hydraulic limitations of the vibrator.

In an embodiment, the piston stroke (i.e., amplitude) is measured and set at a selected high frequency and the stroke is then used as a setting for the displacement for the entire sweep across the full frequency spectrum to be delivered into the earth. For example, the piston stroke (i.e., amplitude) is measure at a frequency between about 40 Hz and about 60 Hz, or alternatively, between about 40 Hz and 50 Hz at full or near full power of the hydraulic system of the vibe. The measured stroke length is then used as the setting for the sweep. In another preferred embodiment, the uniform piston stroke is measured at the highest desired frequency to be delivered in the survey and that stroke length is used for the entire sweep throughout the survey.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of operating a seismic vibrator having a baseplate, a baseplate drive connected to the baseplate and arranged for causing up and down motion of the baseplate so as to produce a uniform displacement sweep comprising the steps of:
a) putting the baseplate to the ground to be coupled to the earth;
b) operating the baseplate drive over the desired frequency sweep such that the baseplate moves in an up and down motion and displaces the ground underneath it by a substantially consistent displacement distance over the frequency sweep up to at least 40 Hz.

2. The method of operating a seismic vibrator according to claim 1, wherein a baseplate drive is connected to the baseplate and arranged for causing up and down motion of the baseplate on the ground so as to deliver pulses into the ground.

3. The method according to claim 1, wherein the displacement of the baseplate and the ground underneath it is consistent across the frequency sweep up to at least about 45 Hz.

4. The method according to claim 1, wherein the displacement of the baseplate and the ground underneath it is consistent across the frequency sweep up to at least about 50 Hz.

5. The method according to claim 1, wherein the displacement of the baseplate and the ground underneath it is consistent across the frequency sweep up to at least about 55 Hz.

6. The method according to claim 1, wherein the displacement of the baseplate and the ground underneath it is consistent across the frequency sweep up to at least about 60 Hz.

7. The method according to claim 1, wherein the displacement distance across the entire sweep is approximately the same physical dimension.

8. The method according to claim 1, wherein the displacement distance is between about one quarter of an inch and about five inches.

9. The method according to claim 1, wherein the displacement distance is between about one quarter of an inch and about two inches.

10. The method according to claim 1, wherein the baseplate drive more particularly comprises a piston connected to the baseplate and wherein the baseplate moves in response to a stroke of the piston.

11. The method according to claim 10, further comprising the step of maintaining a uniform piston stroke length during at least a portion of the uniform displacement sweep.

12. The method according to claim 11, wherein the piston stroke is uniform over the entire sweep.

13. The method according to claim 11, wherein the piston stroke requires greater power at higher frequencies.

14. A method of operating a seismic vibrator having a baseplate, a baseplate drive connected to the baseplate and arranged for causing up and down motion of the baseplate on the ground so as to deliver pulses into the ground where the pulses are delivered across a range of frequencies during a sweep where the method comprises the steps of:
a) putting the baseplate to the ground to be coupled to the earth;
b) operating the baseplate drive at a frequency above 40 Hz and measuring the displacement of the baseplate as the pulses are delivered into the ground so as to obtain a measured displacement; and
c) setting the displacement of the baseplate for most frequencies in the sweeps using in the survey to be approximately the measured displacement in step (b).

15. A method of operating a seismic vibrator having a baseplate, a baseplate drive system including a reaction mass associated with the baseplate where the baseplate drive system causes movement of the reaction mass in a vertical up and down motion so as to produce impulses through the baseplate into the ground, wherein the method comprises the steps of:
a) putting the baseplate to the ground to be coupled to the earth;
b) operating the baseplate drive system through a sweep where a sweep comprises moving the reaction mass through a physical displacement distance while changing the frequency at which the reaction mass moves at a start frequency and progresses to an end frequency through the frequencies between the start frequency and end frequency wherein the physical displacement distance of the reaction mass is maintained to be substantially consistent through the sweep up to at least 40 Hz.

16. The method according to claim 15 further including the step of recording the returning wavefield that has reflected and/or refracted from subsurface geological structures.

17. The method according to claim 15, wherein the displacement of the reaction mass is consistent across the frequency sweep up to at least about 45 Hz.

18. The method according to claim 15, wherein the displacement of the reaction mass is consistent across the frequency sweep up to at least about 50 Hz.

19. The method according to claim 15, wherein the displacement of the reaction mass is consistent across the frequency sweep up to at least about 55 Hz.

20. The method according to claim 15, wherein the displacement of the reaction mass is consistent across the frequency sweep up to at least about 60 Hz.
